(19) United States
(12) Patent Application Publication
(10) Pub. No.: US 2023/0322067 A1
(43) Pub. Date: Oct. 12, 2023

(54) EV Trailer Auxiliary Rechargeable Battery Storage System

(71) Applicant: Jeremy Richard Walker, Fort steele (CA)

(72) Inventor: Jeremy Richard Walker, Fort steele (CA)

(21) Appl. No.: 18/089,204

(22) Filed: Dec. 27, 2022

Related U.S. Application Data
(60) Provisional application No. 63/293,908, filed on Dec. 27, 2021.

(51) Int. Cl. B60K 1/04; B60L 50/60

(52) U.S. Cl. CPC B60K 1/04; B60L 50/66; B60L 2200/28; B60L 2200/36; B60K 2001/0444

(57) ABSTRACT

An EV Trailer Auxiliary Rechargeable Battery storage system is designed to store energy via rechargeable batteries. The system is designed to be attached/secured to the undercarriage, frame, or chassis of any type of trailer. The rechargeable batteries intern provides the necessary energy required to increased overall mileage or distance of the electric EV towing vehicle, tractor or power unit when attached to the trailer in combination, as well assist in meeting the daily energy consumption of the electric EV towing vehicle, tractor, or power unit. The System is designed independently to be charged at a standalone charging station when parked at a warehouse, truck stops or recreational locations via the charging ports on the trailer or when the electric EV towing vehicle, tractor, or power unit and the trailer is attached in combination

EV Trailer Auxiliary Rechargeable Battery storage system referred to as E.V.T.A.R.B.S.S. is designed and configured to be installed attached or secured to any type of trailers frame, chassis or undercarriage. The E.V.T.A.R.B.S.S. is designed and manufactured to provide the necessary or supplementary energy needed to increase the overall range and driving distance of an EV towing vehicle, power unit, or tractor when it Is connected in conjunction or series. System is comprised and configured with one or more rechargeable batteries as well an ECU (Electronic Control Unit) to manage the charging and discharge of the rechargeable batteries as well as the distribution of power to the EV towing vehicle, power unit or tractor as needed. The system also includes transmission lines and charging ports to be installed at the rear left and/or right sides as well front of the trailers frame, chassis or undercarriage. Charging of the batteries are facilitated by connecting a E.V.T.A.R.B.S.S. installed trailer alone or EV towing vehicle, power unit or tractor in conjunction or series to an approved charging station or device.

### DESCRIPTION

Referencing the EV Trailer Auxiliary Rechargeable Battery Storage System as E.V.T.A.R.B.S.S per below

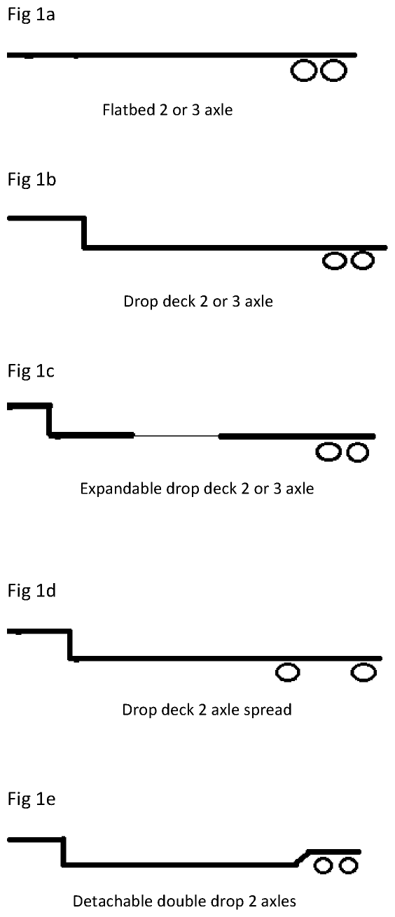

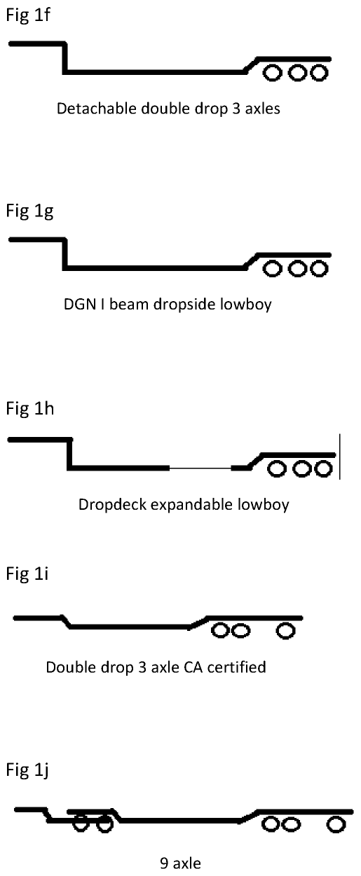

FIG. 1a (Side view) 48′ or 53′ Flatbed 2 or 3 axle trailer. E.V.T.A.R.B.S.S can be installed per trailer under carriage frame or chassis

FIG. 1b (Side View) 48′ or 53′ Drop deck 2 or 3 axle trailer. E.V.T.A.R.B.S.S can be installed per trailer under carriage frame or chassis

FIG. 1c (Side View) Expandable Drop Deck 2 or 3 axle trailer, 42′ closed Expandable to 45′. E.V.T.A.R.B.S.S can be installed per trailer under carriage frame or chassis

FIG. 1d (Side View) 48′ Drop Deck 2 Axle Spread trailer. E.V.T.A.R.B.S.S pan be installed per trailer under carriage frame or chassis

FIG. 1e (Side View) 48′Detachable Double drop 2 axle trailer E.V.T.A.R.B.S.S can be installed per trailer under carriage frame or chassis

FIG. 1f (Side View) 40′ Detachable Double drop 3 axle trailer. E.V.T.A.R.B.S.S can be installed per trailer under carriage frame or chassis

FIG. 1g (Side View) 25′ & 32′ DGN I-Beam Dropside Lowboy trailer. E.V.T.A.R.B.S.S can be installed per trailer under carriage frame or chassis

FIG. 1b (Side View) Dropdeck Expandable Lowboy (Closed 29′, Open 52′). E.V.T.A.R.B.S.S can be installed per trailer under carriage frame or chassis

FIG. 1i (Side View) Double Drop 3 Axle CA certified trailer. E.V.T.A.R.B.S.S can be installed per trailer under carriage frame or chassis

FIG. 1j (Side View) 9 Axle trailer. E.V.T.A.R.B.S.S can be installed per trailer under carriage frame or chassis

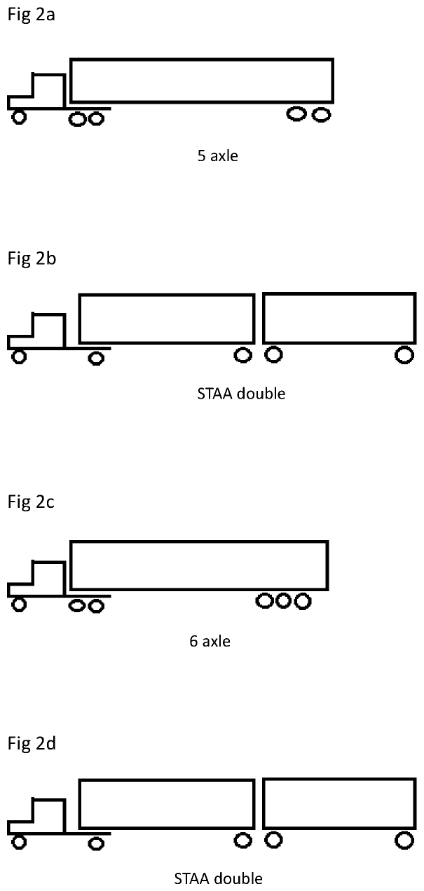

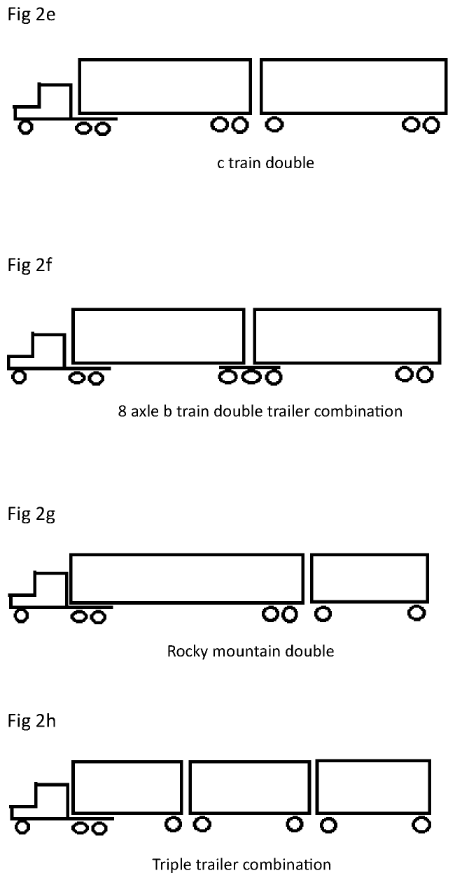

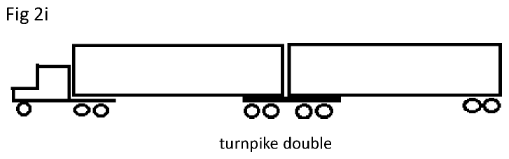

FIG. 2a (Side View) 5 Axle Dry or Reefer Van trailer. E.V.T.A.R.B.S.S can be installed per trailer under carriage frame or chassis

Fib 2b (Side view) STAA Double Dry or Reefer Van trailer. E.V.T.A.R.B.S.S can be installed per trailer under carriage frame or chassis

FIG. 2c (Side View) 6 Axle Dry or Reefer Van trailer. E.V.T.A.R.B.S.S can be installed per trailer under carriage frame or chassis

FIG. 2d (Side View) STAA Double Dry or Reefer Van Trailer. E.V.T.A.R.B.S.S can be installed per trailer under carriage frame or chassis

FIG. 2e (Side view) C train Double Dry or Reefer Van trailer. E.V.T.A.R.B.S.S can be installed per trailer under carriage frame or chassis

FIG. 2f (Side view) 8 Axle B-Train Double Dry or Reefer Van trailer Combination. E.V.T.A.R.B.S.S can be installed per trailer under carriage frame or chassis

FIG. 2g (Side view) Rocky Mountain Double Dry or Reefer Van trailer. E.V.T.A.R.B.S.S can be installed per trailer under carriage frame or chassis

FIG. 2h (Side view) Triple Trailer combination Dry or reefer Van Trailer. E.V.T.A.R.B.S.S can be installed per trailer under carriage frame or chassis

FIG. 2i (Side view) Turnpike double dry or reefer van trailer general. E.V.T.A.R.B.S.S can be installed per trailer under carriage frame or chassis

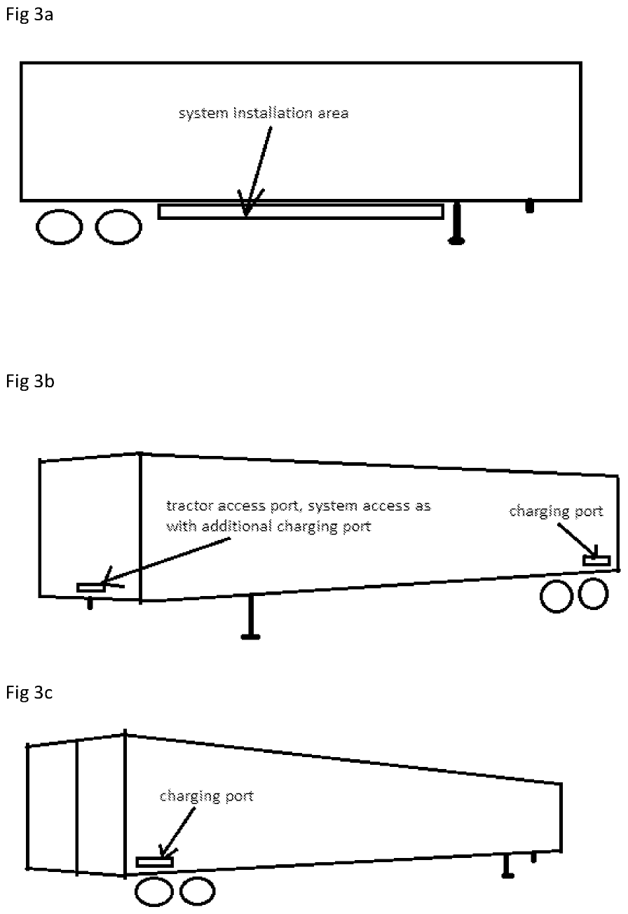

FIG. 3a (Side View) General E.V.T.A.R.B.S.S trailer installation area where as attached to chassis, undercarriage and/or frame.

FIG. 3b (Left Side view/front view) E.V.T.A.R.B.S.S installation where as a rear charging port would be installed per left side rear of trailer as with a front port to be utilized for charging in addition to system access. All of which would be installed per trailer under carriage frame or chassis,

FIG. 3c (Right side/rear view) E.V.T.A.R.B.S.S Installation where as a rear charging port would be installed per right side rear of trailer. All of which would be Installed per trailer under carriage frame or chassis

I. EV Trailer Auxiliary rechargeable battery storage system is attached and or secured to the undercarriage, frame, or chassis of any type of domestic, commercial or RV trailer.

II. EV Trailer Auxiliary rechargeable battery storage system to be used in conjunction with a commercial or domestic electric EV and or tractor, or power unit when the trailer is attached hooked or joined with.

III. EV Trailer Auxiliary rechargeable battery storage system specifically but not limited for the use as an auxiliary power source to increase the distance or mileage being traveled by the electric EV tractor, or power unit when the trailer is attached.

IV. EV Trailer Auxiliary rechargeable battery storage system is made up of several components one or more rechargeable batteries, all necessary mounting hardware, ECM or computer to control the functions of the system on the trailer independently or when attached to an electric EV towing vehicle, tractor or power unit, electrical cable to the charging ports as with charging ports. Communication cable from system to electric EV towing vehicle, tractor or power unit.
